(19) United States
(12) Patent Application Publication
(10) Pub. No.: US 2010/0056739 A1
(43) Pub. Date: Mar. 4, 2010

(54) Transportation of a Monomer Composition in a Transport Means or Pipe

(75) Inventors: Rüdiger Funk, Niedernhausen (DE); Wilfried Heide, Freinsheim (DE); Matthias Weismantel, Jossgrund-Oberndorf (DE); Ulrich Hammon, Mannheim (DE); Andrea Karen Bennett, Mannheim (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: BASF SE, Ludwigsshafen (DE)

(21) Appl. No.: 12/532,502

(22) PCT Filed: Mar. 20, 2008
(86) PCT No.: PCT/EP08/53422

§ 371 Date: Sep. 22, 2009

(30) Foreign Application Priority Data
Mar. 23, 2007 (EP) 07104841.7

(51) Int. Cl. C08F 120/06; C09K 3/00

(52) U.S. Cl. 526/317.1; 252/182.18

(57) ABSTRACT

The invention relates to a method for the transportation of a monomer composition in which a composition comprising an aqueous solution of partially or entirely neutralized acrylic acid or overneutralized acrylic acid is placed in a transport means or sent through a pipe. The method according to the invention is characterized in that it has an increased level of safety during the transportation of acrylic acid monomers, an improved quality of the resulting product, and a high degree of efficiency. The method ensures safe transport of the highly reactive acrylic acid. The amount of polymerization inhibitors added to said acrylic acid may be reduced. An additional advantage is the minimization of the formation of dimeric acrylic acid. Tempering of containers, pipes, and pipelines may be omitted.

The present invention relates to the transport of a monomer composition in a mode of transport or a pipeline.

Water-absorbing resins, also known as superabsorbents or SAPs (super-absorbing polymers), are capable of absorbing aqueous liquids to form a hydrogel and hence of binding them. Superabsorbents therefore find use especially in hygiene articles such as diapers, incontinence pads and pants, sanitary napkins and the like for absorbing aqueous body fluids. Further applications of superabsorbents relate to fire protection, cable sheathing, packing materials and medical applications. A comprehensive overview of SAPs, their use and their preparation is given by F. L. Buchholz and A. T. Graham (editors) in “Modern Superabsorbent Polymer Technology”, Wiley-VCH, New York, 1998.

Among the superabsorbents, those based on acrylic acid are a particularly important substance class.

Typically, monomeric acrylic acid is transported to the point of use of the preparation of the water-absorbing resins. However, acrylic acid is one of the most reactive vinyl monomers known. For this reason, polymerization inhibitors (stabilizers) are added to monomeric acrylic acid in the course of transport in order to avoid premature polymerization.

Common polymerization inhibitors are phenothiazine (PTZ) or phenolic inhibitors, such as hydroquinone or p-methoxyphenol (hydroquinone monomethyl ether, MEHQ). The phenolic inhibitors display their inhibiting action in conjunction with oxygen, for example in contact with air. For road transport, glacial acrylic acid is stabilized typically with 200 ppm of polymerization inhibitor, for example MEHQ.

WO 00/20369 recommends, to avoid free-radical polymerization during the transport of acrylic acid, the addition of a phenolic polymerization inhibitor, such as p-methoxy-phenol, and of a coinhibitor, especially of a manganese cation. The coinhibitor may, for example, be removed with a cation exchanger.

U.S. Pat. No. 5,130,471 describes a stabilized acrylic monomer composition which comprises an acrylic monomer, phenothiazine and a cyclic amine having at least one hydroxyl group.

EP-A 765 856 discloses a stabilized monomer composition which, as well as acrylic acid, comprises a combination (i) of a nitroxyl radical and/or of a hydroxylamine and (ii) a dihetero-substituted benzene compound such as p-methoxyphenol.

Even though MEHQ in conjunction with molecular oxygen stabilizes monomeric acrylic acid exceptionally effectively, it forms colored decomposition products under moist and/or warm climatic conditions. It is known that the use of MEHQ as a stabilizer leads to discoloration of acrylic acid and promotes discoloration during the storage of superabsorbents and products produced therefrom. These discolorations are generally unavoidable, since superabsorbents or products produced therefrom are shipped internationally over long transport routes and are sometimes stored for prolonged periods, often under high air humidity. Especially in the case of use in the hygiene sector, discolored products are undesired.

As a further problem, dimer formation of acrylic acid occurs. In the dimerization, one acrylic acid molecule is added onto the double bond of a further acrylic acid molecule, so as to result in the Michael adduct β-acryloyloxypropionic acid. Dimeric acrylic acid can be detected as early as after a few hours of residence time, so that considerable dimer formation occurs in the course of prolonged residence or transport time. Diacrylic acid formation is promoted by a high temperature and by presence of water.

Dimeric acrylic acid firstly impairs the polymerization of the acrylic acid. Furthermore, copolymerized dimeric acrylic acid can dissociate at elevated temperature. This is manifested in a high residual monomer content of the polymers and leads to emissions and odor nuisance.

To restrict diacrylic acid formation, glacial acrylic acid should therefore be stored and/or transported in substantially anhydrous form and be stored and/or transported at very low temperature.

To suppress undesired diacrylic acid formation, DE 10219089 recommends that the glacial acrylic acid is present in partly crystalline form over the entire duration of transport and/or of storage.

Acrylic acid has a melting point of 14° C. It can be converted to the solid state at temperatures of 14° C. or lower. The thawing of crystallized glacial acrylic acid entails the utmost caution, because the glacial acrylic acid is depleted locally in polymerization inhibitor in the course of crystallizing, and unstabilized acrylic acid can polymerize explosively with great evolution of heat. The external heat source used for thawing must not have too high a temperature level for safety reasons, which is why thawing requires a comparatively long duration.

In practice, it is therefore of great significance to avoid the freezing of acrylic acid during transport and/or storage. Acrylic acid therefore has to be transported in heated and/or insulated vessels or pipelines. Alternatively, the acrylic acid can be loaded with sufficiently high temperature (owing to the risk of explosion, however, up to a maximum of about 30° C.), so that the temperature does not go below 15° C. up to the arrival at the intended site. Higher temperatures, though, promote the formation of dimeric acrylic acid.

It is an object of the invention to specify a process for the safe transport of a monomer composition in a mode of transport or a pipeline, which minimizes or overcomes the above problems. It is an object of the invention especially to specify a transport process in which the amount of polymerization inhibitor, such as p-methoxyphenol, required for safe transport can be reduced.

The object is achieved by a process for transporting a monomer composition in a mode of transport or a pipeline, wherein the monomer composition comprises an aqueous solution of partly or fully neutralized acrylic acid or overneutralized acrylic acid.

The process according to the invention is notable for increased safety in the course of transport of acrylic acid monomers, improved quality of the resulting products and high economic viability.

The use of the process according to the invention ensures safe transport of the highly reactive acrylic acid. The endangerment potential in the case of damage as a result of premature polymerization with extreme evolution of heat, as is present in the case of glacial acrylic acid, is completely ruled out by the process according to the invention.

The use amount of polymerization inhibitors can be reduced. A complicated removal of polymerization inhibitors, for example by treatment with activated carbon immediately before the polymerization, can be dispensed with. Equally, the reduced use amount of polymerization inhibitors brings about lasting stability of the products prepared with respect to discolorations originating from the inhibitor.

The provision of the aqueous solution of partly neutralized acrylic acid dispenses with the steps of dissolving or neutralization immediately before the polymerization at the polymerization site.

A further important advantage of the process according to the invention is the minimization of the formation of dimeric acrylic acid. The formation of dimeric acrylic acid is dependent on the pH and hence on the degree of neutralization. In partly or fully neutralized acrylic acid or overneutralized acrylic acid, the formation of dimeric acrylic acid is suppressed. Removal of dimeric acrylic acid before the polymerization can be dispensed with.

An additional advantage is that temperature control of vessels and pipelines in which the monomer composition is conducted can be dispensed with, since the composition crystallizes at much lower temperatures than pure acrylic acid.

Owing to the excellent safety and the resulting simplifications in the process, the process according to the invention features high economic viability.

The modes of transport with which the monomer composition can be transported include modes of transport for road, rail or ship transport, especially trucks, tankers or container ships. They may have tank devices which are connected to the mode of transport in a fixed manner or be laden with vessels which are suitable for accommodating liquids, for example tank containers. Pipelines include all overland pipelines. The pipelines also include temporary connections for the loading and unloading of modes of transport.

In general, the residence time of the monomer composition in the mode of transport or the pipeline is at least 1 hour, usually at least 5 hours, for example at least 10 hours. In the case of transport in a mode of transport, the residence time may, for example, be from 6 hours to 25 days, in many cases from 12 to 48 hours, usually from 24 to 36 hours. In the case of transport in a mode of transport, the “residence time” is regarded as the time from the filling of the mode of transport or of a vessel to be loaded onto the mode of transport up to its complete emptying. In the case of transport in a pipeline, the “residence time” is considered to be the mean residence time which arises arithmetically from the empty volume of the pipeline (length multiplied by cross-sectional area) and the throughput (volume per unit time).

The increased safety of the process according to the invention is manifested particularly when large coherent volumes of the monomer composition are transported, for example a volume of at least 1 m³, preferably at least 5 m³ or at least 20 m³. When a tank or vessel of a mode of transport is compartmented, the “coherent volume” is regarded as the volume of one compartment. In the case of transport in a pipeline, the “coherent volume” is regarded as the empty volume of the pipeline (length multiplied by cross-sectional area).

In general, the monomer composition is kept during the transport at a temperature in the range from −10 to 25° C., preferably from −5 to 15° C., especially from 0 to 10° C.

Suitable neutralizing agents are especially alkali metal hydroxides, alkali metal carbonates or alkali metal hydrogencarbonates. The acrylic acid is thus present entirely or partly as an alkali metal salt, especially entirely or partly as the sodium and/or potassium salt. Further useful neutralizing agents include ammonia and amines, such as triethanolamine.

“Overneutralized acrylic acid” is understood to mean an acrylic acid solution which has been admixed with a greater amount of neutralizing agent than is required for the complete neutralization of the acrylic acid. The preferred degree of neutralization of the acrylic acid is from 20 to 110 mol %, for example from 20 to 100 mol %, preferably from 20 to 80 mol %, especially from 40 to 75 mol %. In particular embodiments, the degree of neutralization is from 100 to 110 mol %.

The monomer composition comprises an aqueous solution of partly or fully neutralized acrylic or overneutralized acrylic acid, i.e. a homogenous mixture of acrylic acid/acrylic salts, water and, optionally, excess neutralizing agent, the molar fraction of water being generally more than 50 mol %, based on the sum of the molar amounts of acrylic acid/acrylic salts, water and, where used, excess neutralizing agent. The composition comprises preferably from 16 to 56% by weight, especially from 24 to 40% by weight, most preferably from 28 to 36% by weight, of acrylic acid/acrylic salts, calculated as acrylic acid, i.e. both acrylic salts and free acrylic acid are calculated as acrylic acid (with a molar mass of 72.06 g/mol).

In one embodiment, the monomer composition is essentially free of polymerization inhibitors.

For safety reasons and owing to regulatory requirements, complete dispensation with polymerization inhibitors is usually undesired. The monomer composition therefore generally comprises at least one polymerization inhibitor.

Suitable polymerization inhibitors are phenothiazine, phenolic polymerization inhibitors such as phenol, hydroquinone, p-methylphenol, tocopherols, 2,5-di-tert-butyl-hydroquinone, chromanol derivatives such as 2,2,5,7,8-pentamethyl-6-chromanol, 2,2,5,7-tetramethyl-6-chromanol, 2,2,5,8-tetramethyl-6-chromanol, 2,2,7,8-tetramethyl-6-chromanol, 2,2,5-trimethyl-6-chromanol, 2,2,7-trimethyl-6-chromanol, 2,2,8-trimethyl-6-chromanol, nitroxyl radicals such as OH-TEMPO, and other known polymerization inhibitors.

In many cases, it is preferred that the polymerization inhibitor used is p-methoxyphenol and the acrylate monomer composition is essentially free of other polymerization inhibitors. When p-methoxyphenol is used, the composition preferably comprises dissolved oxygen and/or is in contact with the ambient air or an oxygen-containing gas space.

Preferably, the total content in the monomer composition of polymerization inhibitor(s) is less than 100 ppm, preferably less than 50 ppm, especially less than 40 ppm, most preferably less than 20 ppm, based on acrylic acid.

In particular embodiments, the content in the monomer composition of p-methoxy-phenol in ppm, based on acrylic acid, is equal to χ or less, where χ is given by the equation:

χ=200−1.5·DN,

preferably

χ=200−1.8·DN,

in which DN is the degree of neutralization of the acrylic acid in mol percent and DN is in the range from 20 to 110 mol %.

The monomer composition comprises generally less than 100 ppm, in particular less than 20 ppm and especially less than 10 ppm of those impurities which adversely affect the polymerization of acrylic acid. The content of aromatic aldehydes such as benzaldehyde and furfural is preferably below 25 ppm and will in particular not exceed 15 ppm. The content of process inhibitors such as phenothiazine is likewise preferably below 10 ppm and will in particular not exceed 5 ppm or 2 ppm.

Preferably, the following impurities are present in the monomer composition in not more than the concentration specified:

| | | |
|---|---|---|
| Dimeric acrylic acid | 1200 | ppm |
| Acrolein | 50 | ppm |
| Allyl alcohol | 50 | ppm |
| Allyl acrylate | 20 | ppm |
| Protoanemonin | 50 | ppm |
| Propionic acid | 300 | ppm |
| Acetic acid | 1000 | ppm |
| Furfural | 22 | ppm |
| Benzaldehyde | 1 | ppm |
| Heavy metals | 5 | ppm (calculated as Pb) |
| Iron | 2 | ppm |
| Phenothiazine | 1 | ppm |

All ppm data are ppm by weight based on acrylic acid.

The monomer composition can be obtained by complete or partial neutralization of glacial acrylic acid with suitable neutralizing agents.

In general, acrylic acid is prepared by catalytic gas phase oxidation of C₃ hydrocarbons such as propane or propene and mixtures thereof with oxygen (for the preparation of acrylic acid from propene see, for example, Ullmanns Encyclopedia of Ind. Chem. 5th ed. on CD-ROM, “Acrylic acid and derivatives, 1.3.1. Propenoxidation”, Wiley-VCH Weinheim 1997; K. Weisärmel, H.-J. Arpe “Industrielle Org. Chem., 4th ed., VCH Verlagsgesellschaft, Weinheim 1994, p. 315-17 and DE-A 29 43 707, DE-C 12 05 502, EP-A 117 146, EP-A 293 224 GB 1,450,986; for the preparation of acrylic acid from propane see, for example, WO 99/20590 and WO 00/53555).

The gaseous reaction mixture formed in the oxidation of C₃ hydrocarbons comprises, as condensable components, as well as a majority of acrylic acid, generally saturated carboxylic acids such as acetic acid and propionic acid, a series of aromatic aldehydes such as furfurals and benzaldehyde, possibly aliphatic aldehydes such as formaldehyde, acrolein and possibly acetaldehyde and propionaldehyde, proto-anemonin and various unsaturated or aromatic carboxylic acids and anhydrides thereof, for example benzoic acid, maleic acid, maleic anhydride and phthalic anhydride.

For obtaining the acrylic acid from the reaction gas, numerous processes are known. For example, a removal of the acrylic acid from the hot reaction gas can be achieved by absorption into a suitable absorbent, for example by countercurrent absorption with a high-boiling solvent, for example a mixture of diphenyl ether and diphenyl (see DE-A 21 36 396, DE-A 43 08 087 and Ullmanns Encyclopedia of Ind. Chem. 5th ed. on CD-ROM, loc. cit.) or by absorption in water (see, for example, EP-A 511 111 and literature cited there), and the acrylic acid can be obtained by subsequently removing the absorbent, for example by means of distillative separating processes.

In other processes, all condensable components of the reaction gas, i.e. acrylic acid, the water of reaction and the abovementioned impurities, are substantially completely condensed (so-called total condensate). The aqueous acrylic acid obtained here is subsequently substantially freed of water by means of distillation with azeotroping agents (see, for example, DE-A 34 29 391 and JP-A 1124766), by extraction processes with organic solvents (see, for example, DE-A 21 64 767, JP-A 58140039, U.S. Pat. No. 3,553,261, U.S. Pat. No. 4,219,389, GB 1,427,223, U.S. Pat. No. 3,962,074 and DE 23 23 328).

The abovementioned processes afford crude acrylic acid products which are referred to as crude acrylic acid.

The further purification of the crude acrylic acid can be effected by distillation. However, the distillation of acrylic acid is not unproblematic, since it polymerizes very readily in the case of thermal stress. Process polymerization inhibitors therefore have to be added to the acrylic acid during the distillation. The acrylic acid obtained as the distillate is then admixed with a polymerization inhibitor for transport and/or storage, for example hydroquinone monomethyl ether (MEHQ).

As alternatives to distillation, the crystallization of acrylic acid in various ways has also been proposed in the prior art, for example in U.S. Pat. No. 4,493,719, EP-A 616 998, EP-A 648 520, EP-A 715 870, EP 776 875, WO 98/25889 and WO 01/77056. To obtain the purified acrylic acid, the crystals are melted. Owing to the high polymerization tendency of the acrylic acid melt obtained, polymerization inhibitors such as MEHQ have to be added at this time, which has the consequence of the above-mentioned disadvantages.

In a particularly appropriate manner, acrylic acid suitable for the preparation of acrylic acid polymers, especially for the preparation of acrylic acid-based superabsorbents, is obtained when crude acrylic acid is crystallized in a manner known per se and the crystallized acrylic acid, instead of a melting operation, is dissolved directly in an aqueous alkali solution, especially an aqueous alkali metal hydroxide solution.

Appropriately, the monomer composition according to the process of DE 102 21 202 is therefore obtained. The process comprises
i) subjecting a crude acrylic acid melt to a one- or multistage crystallization to obtain crystalline acrylic acid and an acrylic acid-containing residual melt enriched in impurities,
ii) substantially or completely removing the residual melt from the crystalline acrylic acid, and
iii) absorbing the crystalline acrylic acid in an amount of an aqueous alkali solution sufficient to dissolve the acrylic acid to obtain a partly or completely neutralized acrylic acid solution.

The crystallization of the crude acrylic acid in step i) is performed in a manner known per se. Typically, the crude acrylic acid is transferred into a crystallizer and a portion of the acrylic acid is crystallized out with cooling. This is substantially or completely removed from the mother liquor, i.e. the residual melt enriched in impurities, by customary processes. If appropriate, the crystalline acrylic acid thus obtained can then be melted and sent to one or more, for example 2, 3, 4, 5 or 6, further successive crystallization stages until the desired degree of purity has been attained. Preference is given to working by the countercurrent principle, i.e. the mother liquor of the particular crystallization stage is sent to the preceding crystallization stage in each case. When the crystallization is performed as a multistage crystallization, small amounts of the stabilizer, preferably of a hydroquinone or of a hydroquinone monoalkyl ether such as hydroquinone monomethyl ether, can be added in the course of melting of the acrylic acid crystals. The amount is then generally in the range from 1 to 200 ppm and especially in the range from 5 to 100 ppm, based on the crystals. However, an addition is in principle required in small amounts only when melting of the acrylic acid is undertaken. In other words, after the last crystallization stage, generally only small amounts, if any, of further stabilizer will be added and the crystals will be dissolved.

In general, the crystallization in the particular crystallization stage is conducted to such an extent that at least 10% by weight and preferably at least 20% by weight of the acrylic acid present in the crude acrylic acid is crystallized out. In general, not more than 90% by weight, preferably not more than 80% by weight and especially not more than 70% by weight of the acrylic acid used in the particular crystallization stage will be crystallized out in order to ensure a sufficient purifying action.

In a particularly preferred embodiment, the crystallization in step i) is effected as a one-stage crystallization, i.e. the crystallization is conducted up to the desired degree of crystallization (step i)), the residual melt, hereinafter also mother liquor, is removed from the crystalline acrylic acid (step ii)) and the crystalline acrylic acid is taken up in the aqueous alkali solution (step iii)).

The residual melt is removed from the crystalline acrylic acid phase in a manner known per se by customary methods for separating solid and liquid phases. It is not necessary to separate the residual melt completely from the crystalline phase. Frequently, the acrylic acid removed in step ii) still comprises up to 10% by weight of mother liquor, for example from 1 to 10% by weight, based on the total amount of acrylic acid removed. In general, before the dissolution of the acrylic acid in step iii), one of the purification steps described below is performed.

The dissolution of the crystalline acrylic acid in step iii) is effected by treating the crystalline acrylic acid with a sufficient amount of an aqueous alkali solution. Aqueous alkali solutions are understood to mean solutions of basic, typically inorganic substances in water, which neutralize acrylic acid and which do not adversely affect the use of the acrylic acid in the polymerization. These include alkali metal bases such as alkali metal carbonates, alkali metal hydrogencarbonates and alkali metal hydroxides, preference being given to the latter. In step iiii), preference is given to using aqueous sodium hydroxide solution or potassium hydroxide solution. The concentration of alkali in these solutions will generally be at least 10% by weight and is preferably in the range from 20 to 60% by weight, especially in the range from 20 to 50% by weight.

The monomer composition is particularly suitable for preparing polymers based on acrylic acid. As is well known, SAPs based on acrylic acid are prepared by free-radical polymerization of aqueous monomer solutions which comprise essentially acrylic acid and/or acrylic salts as the polymerizable monomer. The polymerization is effected preferably as a solution or gel polymerization in homogeneous aqueous phase or as a suspension polymerization, in which case the aqueous monomer solution forms the disperse phase. The water-containing polymer gels obtained in the polymerization are subjected optionally to a coarse comminution and are dried and optionally ground. The particulate polymers thus obtained are generally subsequently surface postcrosslinked.

The invention also relates to a process for preparing water-absorbing resins, in which
a) acrylic acid is prepared and immediately transferred into an aqueous solution of partly or fully neutralized acrylic acid or overneutralized acrylic acid,
b) the monomer composition thus obtained is transported in a mode of transport or through a pipeline,
c) if appropriate, the degree of neutralization of the monomer composition is adjusted and if appropriate further monomers are added, and a solution or gel polymerization is performed.

Immediately before the polymerization, it is possible if appropriate to adjust the degree of neutralization of the monomer composition to a value required for the polymerization. The degree of neutralization for the polymerization is, for example, from 65 to 75 mol % or from 40 to 50 mol %. When the transported monomer composition has a degree of neutralization of, for example, 100 mol %, addition of acrylic acid allows a desired lower degree of neutralization to be established.

As stated, dimeric acrylic acid forms only to a slight degree in the course of the inventive transport. This is advantageous when the polymer obtained after the polymerization is subjected to a high-temperature step in the course of being worked up and/or further-processed, preferably at a temperature of at least 150° C., for example from 160 to 190° C. At this temperature, copolymerized dimeric acrylic acid again splits off one molecule of acrylic acid, which increases the residual monomer content of the finished polymer.

The high-temperature step is, for example, a surface postcrosslinking.

Preference is given to performing the polymerization with substantial or complete exclusion of oxygen. Preference is therefore given to working under an inert gas atmosphere. The inert gas used is especially nitrogen or steam. In particular, it has been found to be useful to flush the aqueous monomer solution to be polymerized or the monomer-containing aqueous polymerization medium with inert gas before and/or during the polymerization.

The polymerization is effected generally within the temperature range from 0° C. to 150° C., preferably in the range of 10° C. and 100° C., and can be performed either at standard pressure or under elevated or reduced pressure.

Based on its total weight, the monomer composition to be polymerized comprises generally:
from 50 to 99.99% by weight, preferably from 70 to 99.9% by weight and especially from 80 to 99.8% by weight of acrylic acid (salts) as monomer A,
from 0 to 49.99% by weight, especially from 0 to 29.9% by weight and especially from 0 to 19.8% by weight of one or more monoethylenically unsaturated monomers B copolymerizable with acrylic acid, and
from 0.01 to 20% by weight, especially from 0.1 to 15% by weight and especially from 0.2 to 3% by weight of at least one crosslinking compound C.

Here and hereinafter, all parts by weight are based on the total weight of all monomers to be polymerized, while weights of acid-bearing monomers which may also be present as salts are always based on the acid form.

Examples of suitable monomers B are acid-bearing monomers B1 other than acrylic acid, for example monoethylenically unsaturated mono- and dicarboxylic acids having preferably from 4 to 8 carbon atoms, such as methacrylic acid, ethacrylic acid, α-chloroacrylic acid, crotonic acid, maleic acid, maleic anhydride, itaconic acid, citraconic acid, mesaconic acid, glutaconic acid, aconitic acid and fumaric acid; monoesters of monoethylenically unsaturated dicarboxylic acids having from 4 to 10, preferably from 4 to 6 carbon atoms, for example of maleic acid, such as monomethyl maleate; monoethylenically unsaturated sulfonic acids and phosphonic acids, for example vinylsulfonic acid, allylsulfonic acid, sulfoethyl acrylate, sulfoethyl meth-acrylate, sulfopropyl acrylate, sulfopropyl methacrylate, 2-hydroxy-3-acryloyloxypropyl-sulfonic acid, 2-hydroxy-3-methacryloyloxypropylsulfonic acid, styrenesulfonic acid, 2-acrylamido-2-methylpropanesulfonic acid, vinylphosphonic acid and allylphosphonic acid and the salts, especially the sodium, potassium and ammonium salts, of these acids.

Preferred monomers B1 are methacrylic acid, vinylsulfonic acid, styrenesulfonic acid, 2-acrylamido-2-methylpropansulfonic acid or mixtures of these acids. The proportion of monomers B1 in the total amount of monomers makes up, if desired, preferably from 0.1 to 29.9% by weight and especially from 0.5 to 19.8% by weight, based on the total amount of monomers.

To optimize the properties of the inventive polymers, it may be advisable to use monoethylenically unsaturated monomers B2 which do not bear any acid groups but are copolymerizable with acrylic acid and, if appropriate, the monomers B1 and do not have crosslinking action. These include, for example, monoethylenically unsaturated nitrites such as acrylonitrile, methacrylonitrile, the amides of the aforementioned monoethylenically unsaturated carboxylic acids, e.g. acrylamide, methacrylamide, N-vinylamides such as N-vinylformamide, N-vinylacetamide, N-methylvinylacetamide, N-vinylpyrrolidone and N-vinylcaprolactam. The monomers B2 also include vinyl esters of saturated C₁-C₄-carboxylic acids such as vinyl formate, vinyl acetate and vinyl propionate, alkyl vinyl ethers having at least 2 carbon atoms in the alkyl group, e.g. ethyl vinyl ether or butyl vinyl ether, esters of monoethylenically unsaturated C₃-C₆-carboxylic acids, e.g. esters of monohydric C₁-C₁₈-alcohols and acrylic acid, methacrylic acid or maleic acid, acrylic and methacrylic esters of alkoxylated monohydric saturated alcohols, for example of alcohols having from 10 to 25 carbon atoms, which have been reacted with from 2 to 200 mol of ethylene oxide and/or propylene oxide per mole of alcohol, and monoacrylic esters and monomethacrylic esters of polyethylene glycol or polypropylene glycol, where the molar masses (Mn) of the polyalkylene glycols may, for example, be up to 2000. Further suitable monomers B2 are styrene and alkyl-substituted styrenes such as ethylstyrene or tert-butylstyrene. The proportion of monomers B2 in the total amount of monomers will preferably not exceed 20% by weight and makes up, if desired, preferably from 0.1 to 20% by weight.

Useful crosslinking compounds C include those compounds which have at least two, for example 2, 3, 4 or 5, ethylenically unsaturated double bonds in the molecule. These compounds are also referred to as crosslinker monomers C1. Examples of compounds C1 are N,N′-methylenebisacrylamide, polyethylene glycol diacrylates and polyethylene glycol dimethacrylates, each of which derives from polyethylene glycols of a molecular weight from 106 to 8500, preferably from 400 to 2000, trimethylolpropane triacrylate, trimethylolpropane trimethacrylate, ethylene glycol diacrylate, ethylene glycol dimethacrylate, propylene glycol diacrylate, propylene glycol dimethacrylate, butanediol diacrylate, butanediol dimethacrylate, hexanediol diacrylate, hexanediol dimethacrylate, diethylene glycol diacrylate, diethylene glycol dimethacrylate, triethylene glycol diacrylate, triethylene glycol dimethacrylate, dipropylene glycol diacrylate, dipropylene glycol dimethacrylate, tripropylene glycol diacrylate, tripropylene glycol dimethacrylate, allyl methacrylate, diacrylates and dimethacrylates of block copolymers of ethylene oxide and propylene oxide, di-, tri-, tetra- or pentaacrylated or -methacrylated polyhydric alcohols, such as glycerol, trimethylolpropane, pentaerythritol or dipentaerythritol, esters of monoethylenically unsaturated carboxylic acids with ethylenically unsaturated alcohols such as allyl alcohol, cyclohexanol and dicyclopentenyl alcohol, e.g. allyl acrylate and allyl methacrylate, and also triallylamine, dialkyldiallylammonium halides such as dimethyldiallylammonium chloride and diethyldiallylammonium chloride, tetraallylethylenediamine, divinylbenzene, diallyl phthalate, polyethylene glycol divinyl ethers of polyethylene glycols of molecular weight from 106 to 4000, trimethylolpropane diallyl ether, butanediol divinyl ether, pentaerythrityl triallyl ether, reaction products of 1 mol of ethylene glycol diglycidyl ether or polyethylene glycol diglycidyl ether with 2 mol of pentaerythrityl triallyl ether or allyl alcohol, and divinylethyleneurea. The proportion of monomers C1 in the monomer mixture to be polymerized is preferably from 0.01 to 5% by weight and especially from 0.2 to 3% by weight.

The compounds which function as crosslinking compounds C may also be compounds C2 having functional groups which may react with at least 2 carboxyl groups of the polymer to form a covalent bond (functional groups which are complementary to carboxyl groups). Useful crosslinkers C also include crosslinking monomers C3 which, as well as an ethylenically unsaturated double bond, have at least one further functional group complementary to carboxyl groups. Also useful are polymers having a multitude of such functional groups. Suitable functional groups are, for example, hydroxyl, amino, epoxy and aziridine groups, and also isocyanate, ester and amido groups and alkyloxysilyl groups. The suitable crosslinkers of this type include, for example, aminoalcohols such as ethanolamine or triethanolamine, di- and polyols such as 1,3-butanediol, 1,4-butanediol, ethylene glycol, diethylene glycol, triethylene glycol, tetraethylene glycol, polyethylene glycol, glycerol, polyglycerol, propylene glycol, polypropylene glycol, trimethylolpropane, pentaerythritol, polyvinyl alcohol, sorbitol, starch, block copolymers of ethylene oxide and propylene oxide, polyamines such as ethylenediamine, diethylenetriamine, triethylenetetramine, tetraethylenepentamine, pentaethylenehexamine and polyethyleneimines, and also polyamines having molar masses of up to 4 000 000 in each case, esters such as sorbitan fatty acid esters, ethoxylated sorbitan fatty acid esters, polyglycidyl ethers such as ethylene glycol diglycidyl ether, polyethylene glycol diglycidyl ether, glyceryl diglycidyl ether, glyceryl polyglycidyl ether, diglyceryl polyglycidyl ether, polyglyceryl polyglycidyl ether, sorbitol polyglycidyl ether, pentaerythrityl polyglycidyl ether, propylene glycol diglycidyl ether and polypropylene glycol diglycidyl ether, polyaziridine compounds such as 2,2-bis-hydroxymethylbutanol tris[3-(1-aziridinyl)propionate], diamides of carbonic acid such as 1,6-hexamethylenediethyleneurea, diphenylmethane-bis-4,4′-N,N′-diethyleneurea, halogen-epoxy compounds such as epichlorohydrin and α-methylepifluorohydrin, polyisocyanates such as tolylene 2,4-diisocyanate and hexamethylene diisocyanate, alkylene carbonates such as 1,3-dioxolan-2-one and 4-methyl-1,3-dioxolan-2-one, and also bisoxazolines and oxazolidones, polyamidoamines and their reaction products with epichlorohydrin, and also polyquaternary amines such as condensation products of dimethylamine with epichlorohydrin, homo- and copolymers of diallyldimethyl-ammonium chloride and homo- and copolymers of dimethylaminoethyl (meth)acrylate, which have optionally been quaternized with, for example, methyl chloride. Examples of compounds C3 are hydroxyalkyl acrylates and methacrylates, and glycidyl esters of the aforementioned ethylenically unsaturated carboxylic acids and ethylenically unsaturated glycidyl ethers.

The monomers C preferably comprise at least one monomer C1 in the above-mentioned amounts. Preference is given to effecting the polymerization in the absence of compounds C2.

Suitable graft bases may be of natural or synthetic origin. They include starches, i.e. native starches from the group of corn starch, potato starch, wheat starch, rice starch, tapioca starch, sorghum starch, manioc starch, pea starch or mixtures thereof, modified starches, starch degradation products, for example oxidatively, enzymatically or hydrolytically degraded starches, dextrins, e.g. roast dextrins and lower oligo- and polysaccharides, e.g. cyclodextrins having from 4 to 8 ring members. Useful oligo- and polysaccharides also include cellulose, starch derivatives and cellulose derivatives. Also suitable are polyvinyl alcohols, homo- and copolymers of N-vinylpyrrolidone, polyamines, polyamides, hydrophilic polyesters or polyalkylene oxides, especially polyethylene oxide and polypropylene oxide. Suitable polyalkylene oxides have the general formula I

R¹—O—(CH₂—CHX—O)ₙ—R²

in which R¹, R² are each independently hydrogen; C₁-C₄-alkyl; C₂-C₆-alkenyl, especially phenyl; or (meth)acryloyl; X is hydrogen or methyl and n is an integer from 1 to 1000, especially from 10 to 400.

Useful polymerization reactors include the reactors customary for preparation, especially belt reactors, extruders and kneaders (see “Modern Superabsorbent Polymer Technology”, chapter 3.2.3). The polymers are more preferably prepared by a continuous or batchwise kneading process or a continuous belt polymerization process.

Useful inhibitors are in principle all compounds which, on heating to polymerization temperature or due to a redox reaction, decompose to form radicals. The polymerization can also be induced by the action of high-energy radiation, for example UV radiation, in the presence of photoinitiators. Initiation of the polymerization by the action of electron beams on the polymerizable aqueous mixture is also possible.

Suitable initiators are, for example, peroxo compounds such as organic peroxides, organic hydroperoxides, hydrogen peroxide, persulfates, perborates, azo compounds and the so-called redox catalysts. Preference is given to water-soluble initiators. In some cases, it is advantageous to use mixtures of different polymerization initiators, for example mixtures of hydrogen peroxide and sodium peroxodisulfate or potassium peroxodisulfate. Suitable organic peroxides are, for example, acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl per-2-ethylhexanoate, tert-butyl perisononanoate, tert-butyl permaleate, tert-butyl perbenzoate, di(2-ethylhexyl)peroxydicarbonate, dicyclohexyl peroxydicarbonate, di(4-tert-butylcyclohexyl)peroxydicarbonate, dimyristyl peroxydicarbonate, diacetylperoxydicarbonate, allyl perester, cumyl peroxyneodecanoate, tert-butyl per-3,5,5-trimethylhexanoate, acetylcyclohexylsulfonyl peroxide, dilauryl peroxide, dibenzoyl peroxide and tert-amyl perneodecanoate. Particularly suitable polymerization initiators are water-soluble azo initiators, e.g. 2,2′-azobis(2-amidinopropane)dihydrochloride, 2,2′-azobis(N,N′-dimethylene)isobutyramidine dihydrochloride, 2-(carbamoylazo)isobutyronitrile, 2,2′-azobis[2-(2′-imidazolin-2-yl)propane]dihydrochloride and 4,4′-azobis(4-cyanovaleric acid). The polymerization initiators mentioned are used in customary amounts, for example in amounts of from 0.01 to 5% by weight, preferably from 0.05 to 2.0% by weight, mostly 0.05 to 0.30% by weight, based on the monomers to be polymerized.

Redox initiators are preferred. They comprise, as an oxidizing component, at least one of the above-specified peroxo compounds and, as a reducing component, for example, ascorbic acid, glucose, sorbose, ammonium sulfite, hydrogensulfite, thiosulfate, hyposulfite, pyrosulfite or sulfide, alkali metal sulfite, hydrogensulfite, thiosulfate, hyposulfite, pyrosulfite or sulfide, metal salts such as iron(II) ions or sodium hydroxymethylsulfoxylate. Preference is given to using, as the reducing component of the redox catalyst, ascorbic acid or sodium sulfite. As a reducing component preference is also given to a mixture of the sodium salt of 2-hydroxy-2-sulfinatoacetic acid, the disodium salt of 2-hydroxy-2-sulfonatoacetic acid, and sodium bisulfite. Mixtures of this kind are available as Bruggolite® FF6 and Brüggolite® FF7 (Brüggemann Chemicals; Heilbronn; DE). Based on the amount of monomers used in the polymerization, for example, from 3×10⁻⁶ to 1 mol % of the reducing component of the redox catalyst system and from 0.001 to 5.0 mol % of the oxidizing component of the redox catalyst are used.

When the polymerization is induced by the action of high-energy radiation, so-called photoinitiators are typically used as the initiator.

The moisture content of the water-containing polymer gel is generally in the range from 20 to 80% by weight. The water-containing polymer gel is then converted to a particulate polymer in a manner known per se and subsequently surface postcrosslinked.

To this end, the water-containing polymer gel obtained in the polymerization is generally first comminuted by known methods. The coarse comminution of the water-containing polymer gels is effected by means of customary tearing and/or cutting tools, for example by the action of a discharge pump in the case of polymerization in a cylindrical reactor or by means of a cutting roller or cutting roller combination in the case of belt polymerization. Further comminution takes place in general using a gel chopper. In the case of polymerization in a kneading reactor, the direct product is a dryable, water-containing polymer gel.

The coarsely comminuted polymer gel thus obtained is subsequently dried at elevated temperature, for example in the range from 80° C. to 250° C. and especially in the range from 100° C. to 180° C., by known processes (see “Modern Superabsorbent Polymer Technology” chapter 3.2.5). In this case, the particulate polymers are obtained in the form of powders or granules, which, if appropriate, are subjected to further milling and screening operations to adjust the particle size (see “Modern Superabsorbent Polymer Technology” chapter 3.2.6 and 3.2.7).

The process according to the invention preferably comprises a surface postcrosslinking. The surface postcrosslinking is effected in a manner known per se with dried, preferably ground and screened-off, polymer particles. For the surface crosslinking, compounds having functional groups which can react with at least two carboxyl groups of the polymers with crosslinking are used (postcrosslinkers). The functional groups may be present in latent form in the postcrosslinker, i.e. they are not released until under the reaction conditions of the surface postcrosslinking. Suitable functional groups in postcrosslinkers are hydroxyl groups, glycidyl groups, alkoxysilyl groups, aziridine groups, primary and secondary amino groups, N-methylol groups (=N-hydroxymethyl groups, N—CH₂—OH groups), oxazolidine groups, urea and thiourea groups, reversibly or irreversibly blocked isocyanate groups and cyclic carbonate groups as in ethylene carbonate. For the surface postcrosslinking, the postcrosslinkers are applied to the surface of the polymer particles, preferably in the form of an aqueous solution. The aqueous solution may comprise water-miscible organic solvents. Suitable solvents are, for example, C₁-C₄-alcohols such as methanol, ethanol, isopropanol, or ketones such as acetone and methyl ethyl ketone.

Suitable postcrosslinkers are, for example:
di- or polyglycidyl compounds such as phosphonic acid diglycidyl ether or ethylene glycol diglycidyl ether, bischlorohydrin ethers of polyalkylene glycols,
alkoxysilyl compounds,
polyaziridines, compounds comprising aziridine units and based on polyethers or substituted hydrocarbons, for example bis-N-aziridinomethane,
polyamines or polyamidoamines and their reaction products with epichlorohydrin,
diols and polyols, e.g. ethylene glycol, 1,2-propanediol, 1,4-butanediol, glycerol, methyltriglycol, trimethylolethane, trimethylolpropane, polyethylene glycols having a mean molecular weight Mw of 200-10 000, di- and polyglycerol, pentaerythritol, sorbitol, the oxethylates of these polyols and esters thereof with carboxylic acids or with carbonic acid, such as ethylene carbonate or propylene carbonate,
carbonic acid derivatives such as urea, thiourea, guanidine, dicyandiamide, 2-oxazolidinone and derivatives thereof, bisoxazoline, polyoxazolines, di- and polyisocyanates,
di- and poly-N-methylol compounds, for example methylenebis(N-methylol-methacrylamide) or melamine-formaldehyde resins,
compounds with two or more blocked isocyanate groups, for example trimethylhexamethylene diisocyanate blocked with 2,2,3,6-tetramethyl-4-piperidinone.

If required, acidic catalysts such as p-toluenesulfonic acid, phosphoric acid, boric acid or ammonium dihydrogenphosphate can be added.

The crosslinker solution is applied preferably by spraying-on a solution of the crosslinker in customary reaction mixers or mixing and drying units, for example Patterson-Kelly mixers, DRAIS turbulence mixers, Lödige mixers, screw mixers, pan mixers, fluidized bed mixers and Schugi-Mix. After the crosslinker solution has been sprayed on, a thermal treatment step can follow, preferably in a downstream dryer, at a temperature between 80 and 230° C., preferably between 100 and 160° C. or 180 and 200° C., over a period of from 5 minutes to 6 hours, preferably from 10 minutes to 2 hours and more preferably from 10 minutes to 1 hour, in the course of which both cleavage products and solvent fractions can be removed. The drying can, though, also be effected in the mixer itself, by heating the jacket or blowing in a preheated carrier gas.

The resulting SAPs are suitable especially for the production of hygiene articles. The construction and the form of hygiene articles, especially diapers, napkins and incontinence pads and pants for adults, is common knowledge and is described, for example, in EP-A-0 316 518, EP-A-0 202 127, DE 19737434, WO 00/65084, WO 00/65348 and WO 00/35502.

Typical hygiene articles in the form of diapers, napkins and incontinence pads and pants comprise:
(A) an upper liquid-pervious cover
(B) a lower liquid-impervious layer
(C) a core disposed between (A) and (B), comprising
(C1) 10-100% by weight of water-absorbing resin
(C2) 0-90% by weight of hydrophilic fiber material
(D) if appropriate a tissue layer disposed immediately above and below the core (C) and
(E) if appropriate an absorption layer disposed between (A) and (C).

The liquid-pervious cover (A) is a layer which is in direct contact with the skin. The material for this purpose consists of customary synthetic or semisynthetic fibers or films of polyester, polyolefins, rayon or natural fibers such as cotton. In the case of nonwoven materials, the fibers should generally be bound by binders such as polyacrylates. Preferred materials are polyesters, rayon and blends thereof, polyethylene and polypropylene.

The liquid-impervious layer (B) consists generally of a film of polyethylene or polypropylene.

The core (C) comprises, as well as the water-absorbing resin (C1), hydrophilic fiber material (C2). Hydrophilic is understood to mean that aqueous liquids are distributed rapidly over the fiber. Usually, the fiber material is cellulose, modified cellulose, rayon, polyesters such as polyethylene terephthalate. Particular preference is given to cellulose fibers such as chemical pulp. The fibers generally have a diameter of from 1 to 200 μm, preferably from 10 to 100 μm. In addition, the fibers have a minimum length of 2 mm.

The proportion of the hydrophilic fiber material based on the total amount of the core is preferably from 20 to 80% by weight, more preferably from 40 to 70% by weight.

The invention is illustrated in more detail with the following examples.

### EXAMPLE 1

### Storage Stability of Aqueous Acrylic Acid and Neutralized Acrylic Acid

For the preparation of the unneutralized acrylic acid solution, 1071.3 g of DI (fully demineralized) water were introduced, and 428.7 g (5.95 mol) of acrylic acid (stabilized with 50 ppm of MEHQ) were dissolved therein. To prepare an aqueous sodium acrylate solution (100% degree of neutralization), 595.4 g of demineralized water were charged to a 3 l plastic beaker, and 476.0 g of aqueous sodium hydroxide solution (50% strength) were dissolved therein. Via a 500 ml dropping funnel, 428.7 g (5.95 mol) of acrylic acid (stabilized with 50 ppm of MEHQ) were added dropwise. During the addition, the plastic beaker was cooled in an ice bath, and the rate of addition was selected such that the temperature in the interior of the plastic beaker did not exceed 30° C.

Aliquots (400 g) of the thus-prepared aqueous acrylic acid solution and sodium acrylate solution were introduced into 500 ml screw-top lid glass vessels. The lid was screwed on loosely, allowing overpressure to escape in the case of a polymerization. The aliquots were stored at 60° C. and the storage stability were monitored by means of viscosity measurement.

To carry out the viscosity measurement, the samples were each cooled to 22° C. (+/−2° C.). The viscosity was measured using a Brookfield viscosimeter (model LVT, spindle 1).

The results of the storage experiments are summarized in the tables below.

Storage at 60° C.

| | Sodium acrylate solution | Aqueous acrylic acid |
|---|---|---|
| Day of storage | Viscosity [mPa*s] (observation) | |
| 0 | 7.5 | 3.0 |
| 2 | 6.5 | 3.0 |
| 3 | 5.0 | 2.0 |
| 4 | 6.5 | 2.5 |
| 7 | 6.5 | 2.5 |
| 8 | 6.5 | 2.5 |
| 9 | 9.0 | 4.5 (forms strings) |
| 10 | 9.0 | 5.0 |
| 11 | 9.5 | 5.0 |
| 15 | 9.0 | 8.5 (partially polymerized - |
| | | polymer visible) |
| 16 | 9.0 | 9 (partly polymerized fraction |
| | | has become greater) |
| 17 | 9.0 | 13.0 |
| 18 | 9.0 | largely gelled, not measurable |
| 21 | 9.0 | completely gelled |
| 22 | 9.0 | completely gelled |
| 23 | 9.0 | completely gelled |
| 24 | 9.0 | completely gelled |
| 30 | 9.0 | completely gelled |

Storage at 60° C. (repeat experiment)

| | Sodium acrylate solution | Aqueous acrylic acid |
|---|---|---|
| Day of storage | Visual assessment | |
| 2 | unchanged | unchanged |
| 4 | unchanged | unchanged |
| 7 | unchanged | unchanged |
| 9 | unchanged | completely gelled |
| 10 | unchanged | completely gelled |
| 14 | unchanged | completely gelled |
| 17 | unchanged | completely gelled |
| 22 | unchanged | completely gelled |
| 25 | unchanged | completely gelled |

Storage at 60° C. (2nd repeat experiment)

| | Sodium acrylate solution | Aqueous acrylic acid |
|---|---|---|
| Day of storage | Visual assessment | |
| 2 | unchanged | unchanged |
| 4 | unchanged | unchanged |
| 7 | unchanged | unchanged |
| 9 | unchanged | unchanged |
| 10 | unchanged | completely gelled |
| 14 | unchanged | completely gelled |
| 17 | unchanged | completely gelled |
| 22 | unchanged | completely gelled |
| 25 | unchanged | completely gelled |

### EXAMPLE 2

### Formation of β-Acryloyloxypropionic Acid

Aliquots of aqueous acrylic acid solution and sodium acrylate solution were stored at 6° C. or 23° C. for one week and then the amount of β-acryloyloxypropionic acid was determined by HPLC (column: Waters Symmetry 150×3.9 mm; 25° C.; mobile phase: 90% by volume phosphoric acid (0.1% by volume)/10% by volume acetonitrile; detection at 210 nm). The results are summarized in the table below:

Storage at 6° C.

| Degree of | Solids content | β-acryloyloxypropionic acid [ppm] | |
|---|---|---|---|
| neutralization [%] | [% by weight] | initial | after 1 week |
| 0 | 40 | 55 | 173 |
| 100 | 37 | 5 | 5 |

Storage at 23° C.

| Degree of | Solids content | β-acryloyloxypropionic acid [ppm] | |
|---|---|---|---|
| neutralization [%] | [% by weight] | initial | after 1 week |
| 0 | 40 | 29 | 824 |
| 100 | 37 | 7 | 4 |

1. A process for transporting a monomer composition, which comprises transferring a composition comprising an aqueous solution of partly or fully neutralized acrylic acid or overneutralized acrylic acid to a mode of transport or sending the composition through a pipeline.

2. The process according to claim 1, wherein the acrylic acid is present entirely or partly as an alkali metal salt.

3. The process according to claim 2, wherein the acrylic acid is present entirely or partly as a sodium and/or potassium salt.

4. The process according to claim 1, wherein a degree of neutralization of the acrylic acid is from 20 to 110 mol %.

5. The process according to claim 1, wherein the composition comprises from 16 to 56% by weight, of monomer, calculated as acrylic acid.

6. The process according to claim 1, wherein the residence time of the monomer composition in the mode of transport or the pipeline is at least 1 hour.

7. The process according to claim 1, wherein the monomer composition is transported as a coherent volume of at least 1 m³.

8. The process according to claim 1, wherein the monomer composition is essentially free of polymerization inhibitors.

9. The process according to claim 1, wherein the monomer composition comprises at least one polymerization inhibitor.

10. The process according to claim 9, wherein a total content in the monomer composition of polymerization inhibitor(s) is less than 100 ppm, based on acrylic acid.

11. The process according to claim 9, wherein the polymerization inhibitor is p-methoxyphenol and the monomer composition is essentially free of other polymerization inhibitors.

12. The process according to claim 11, wherein the composition comprises dissolved oxygen and/or is in contact with the ambient air or an oxygen-containing gas space.

13. The process according to claim 11, wherein a content in the monomer composition of p-methoxyphenol in ppm, based on acrylic acid, is equal to χ or less, where χ is given by the equation:
χ=200−1.5·DN,
in which DN is a degree of neutralization of the acrylic acid in percent.

14. The process according to claim 1, wherein the monomer composition is suitable for preparing water-absorbing resins.

15. A process for preparing water-absorbing resins, in which
a) acrylic acid is prepared and transferred into an aqueous solution of partly or fully neutralized acrylic acid or overneutralized acrylic acid,
b) the monomer composition thus obtained is transported in a mode of transport or through a pipeline,
c) optionally, a degree of neutralization of the monomer composition is adjusted and optionally further monomers are added, and a solution or gel polymerization is performed.

16. The process according to claim 15, wherein the polymer obtained in step c) is subjected to a high-temperature step in the course of being worked up and/or further-processed.

17. The process according to claim 16, wherein the high-temperature step is a surface postcrosslinking.

18. The process according to claim 1, wherein a degree of neutralization of the acrylic acid is from 20 to 80 mol %.

19. The process according to claim 1, wherein the composition comprises from 24 to 40% by weight, of monomer, calculated as acrylic acid.

20. The process according to claim 9, wherein a total content in the monomer composition of polymerization inhibitor(s) is less than 50 ppm, based on acrylic acid.
